(19) United States
(12) Patent Application Publication
(10) Pub. No.: US 2020/0116255 A1
(43) Pub. Date: Apr. 16, 2020

(54) AUTOMATIC TRANSMISSION CONTROL DEVICE AND AUTOMATIC TRANSMISSION CONTROL METHOD

(71) Applicants: JATCO Ltd, Fuji-shi, Shizuoka (JP); NISSAN MOTOR CO., LTD., Yokohama-shi, Kanagawa (JP)

(72) Inventor: Junki MATSUI, Odawara-shi, Kanagawa (JP)

(73) Assignees: JATCO Ltd, Fuji-shi, Shizuoka (JP); NISSAN MOTOR CO., LTD., Yokohama-shi, Kanagawa (JP)

(21) Appl. No.: 16/626,365

(22) PCT Filed: Jun. 26, 2018
(86) PCT No.: PCT/JP2018/024112

§ 371 Date: Dec. 24, 2019

(30) Foreign Application Priority Data
Jun. 28, 2017 (JP) 2017-126478

(51) Int. Cl. F16H 61/12

(52) U.S. Cl. CPC F16H 61/12; F16H 2061/1208; F16H 2061/1284

(57) ABSTRACT

An automatic transmission control device includes diagnosis means configured to perform an abnormality diagnosis of a rotation sensor on the basis of a maximum cycle and a minimum cycle of a plurality of the pulse signals in a predetermined period.

### TECHNICAL FIELD

The present invention relates to an automatic transmission control device and an automatic transmission control method.

### BACKGROUND ART

JP5-180326A discloses a technique for performing an abnormality diagnosis of one rotation sensor on the basis of pulse signals from two rotation sensors.

### SUMMARY OF INVENTION

With the above technique, at least two rotation sensors are necessary to perform an abnormality diagnosis of a rotation sensor. That is, if there is only one rotation sensor, an abnormality diagnosis of this rotation sensor cannot be performed.

The present invention was developed in view of such a technical problem and aims to enable an abnormality diagnosis of a rotation sensor even if there is only one rotation sensor.

According to one aspect of the present invention, an automatic transmission control device for an automatic transmission with a rotary body for transmitting rotation input from a drive source to drive wheels and a rotation sensor for detecting detection parts provided on the rotary body and outputting pulse signals, comprising diagnosis means configured to perform an abnormality diagnosis of the rotation sensor on the basis of a maximum cycle and a minimum cycle of a plurality of the pulse signals in a predetermined period.

According to another aspect of the present invention, an automatic transmission control method for an automatic transmission with a rotary body for transmitting rotation input from a drive source to drive wheels and a rotation sensor for detecting detection parts provided on the rotary body and outputting pulse signals, comprising performing an abnormality diagnosis of the rotation sensor on the basis of a maximum cycle and a minimum cycle of a plurality of the pulse signals in a predetermined period.

According to these aspects, the abnormality diagnosis is performed on the basis of the maximum cycle and the minimum cycle of the plurality of pulse signals in the predetermined period. Thus, even if there is one rotation sensor, an abnormality diagnosis of this rotation sensor can be performed.

### BRIEF DESCRIPTION OF DRAWINGS

FIG. 1 is a schematic configuration diagram of a vehicle according to an embodiment of the present invention,

FIG. 2 is a diagram showing a rotation sensor,

FIG. 3 is a chart showing pulse signals,

FIG. 4 is a flow chart showing an abnormality diagnosis process for the rotation sensor,

FIG. 5 is a chart showing a case where a signal from the rotation sensor is abnormal, and

FIG. 6 is a chart showing a case where a rotary body has an abnormality.

### DESCRIPTION OF EMBODIMENT

Hereinafter, a vehicle 100 according to an embodiment of the present invention is described with reference to the accompanying drawings.

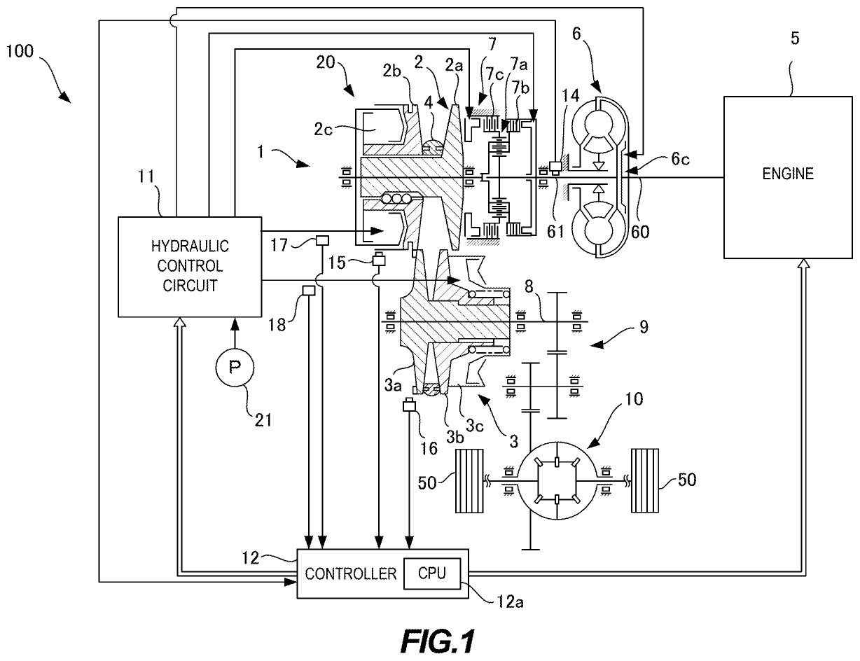

FIG. 1 is a schematic configuration diagram of the vehicle 100. As shown in FIG. 1, the vehicle 100 includes an engine 5 serving as a drive source and an automatic transmission 1 for shifting and transmitting the rotation of the engine 5 to drive wheels 50.

The automatic transmission 1 includes a torque converter 6, a continuously variable transmission mechanism 20 and a forward/reverse switching mechanism 7.

The torque converter 6 includes a lock-up clutch 6c. The lock-up clutch 6c is engaged by having a lock-up pressure supplied thereto from a hydraulic control circuit 11. When the lock-up clutch 6c is engaged, an input shaft 60 and an output shaft 61 of the torque converter 6 are directly coupled and rotate at the same speed.

The continuously variable transmission mechanism 20 includes a primary pulley 2 and a secondary pulley 3 disposed such that V-shaped grooves are aligned, and a belt 4 mounted in the V-shaped grooves of the pulleys 2, 3.

The engine 5 is arranged coaxially with the primary pulley 2, and the torque converter 6 and the forward/reverse switching mechanism 7 are successively provided from the side of the engine 5 between the engine 5 and the primary pulley 2.

The forward/reverse switching mechanism 7 includes a double-pinion planetary gear set 7a as a main constituent element, a sun gear thereof is coupled to the engine 5 via the torque converter 6 and a carrier thereof is coupled to the primary pulley 2. The forward/reverse switching mechanism 7 further includes a forward clutch 7b for directly coupling the sun gear and the carrier of the double-pinion planetary gear set 7a and a reverse brake 7c for fixing a ring gear. Input rotation transmitted from the engine 5 by way of the torque converter 6 is directly transmitted to the primary pulley 2 when the forward clutch 7b is engaged, and the input rotation transmitted from the engine 5 by way of the torque converter 6 is reversed and transmitted to the primary pulley 2 when the reverse brake 7c is engaged.

The forward clutch 7b is engaged by having a clutch pressure supplied thereto from the hydraulic control circuit 11 when a forward travel mode is selected by a select switch (not shown) for selecting an operation mode of the automatic transmission 1. The reverse brake 7c is engaged by having a brake pressure supplied thereto from the hydraulic control circuit 11 when a reverse travel mode is selected by the select switch.

The rotation of the primary pulley 2 is transmitted to the secondary pulley 3 via the belt 4, and the rotation of the secondary pulley 3 is transmitted to the drive wheels 50 by way of an output shaft 8, a gear set 9 and a differential gear device 10.

To enable a change of a speed ratio between the primary pulley 2 and the secondary pulley 3 during the above power transmission, one of conical plates forming the V-shaped groove of each of the primary pulley 2 and the secondary pulley 3 is a fixed conical plate 2a, 3a and the other is a movable conical plate 2b, 3b displaceable in an axial direction.

These movable conical plates 2b, 3b are biased toward the fixed conical plates 2a, 3a by supplying a primary pulley pressure and a secondary pulley pressure to a primary pulley chamber 2c and a secondary pulley chamber 3c, whereby the belt 4 is frictionally engaged with the conical plates to transmit power between the primary pulley 2 and the secondary pulley 3.

In shifting, widths of the V-shaped grooves of the both pulleys 2, 3 are changed by a differential pressure between the primary pulley pressure and the secondary pulley pressure generated to correspond to a target speed ratio, and the target speed ratio is realized by continuously changing winding arc diameters of the belt 4 on the pulleys 2, 3.

The lock-up pressure, the primary pulley pressure, the secondary pulley pressure, the clutch pressure and the brake pressure are controlled by the hydraulic control circuit 11 on the basis of a control signal from a controller (control device, diagnosis means) 12.

The hydraulic control circuit 11 includes a plurality of oil passages and a plurality of solenoid valves. The hydraulic control circuit 11 switches a hydraulic pressure supply path on the basis of a control signal from the controller 12, generates a necessary hydraulic pressure by adjusting a pressure of hydraulic oil supplied from an oil pump 21, and supplies the generated hydraulic pressure to each part of the automatic transmission 1.

The oil pump 21 of the present embodiment is driven, using part of the power of the engine 5. The oil pump 21 may be an electric oil pump.

The controller 12 is configured to include a CPU (Central Processing Unit) 12a, a ROM (Read Only Memory), a RAM (Random Access Memory), an input/output interface, a bus connecting these and the like, and integrally controls a rotation speed and a torque of the engine 5, an engaged state of the lock-up clutch 6c, a speed ratio of the continuously variable transmission mechanism 20, engaged states of the forward clutch 7b and the reverse brake 7c and the like on the basis of signals from various sensors for detecting a state of each part of the vehicle 100.

To the controller 12 are input a selection mode signal from the select switch, a signal from an accelerator pedal opening sensor (not shown) for detecting an operated state of an accelerator pedal (not shown), a signal from a brake switch (not shown) for detecting an operated state of a brake pedal (not shown), a signal from a rotation sensor 14 for detecting the rotation of the output shaft 61 serving as a rotary body, a signal from a rotation sensor 15 for detecting the rotation of the primary pulley 2 serving as a rotary body, a signal from a rotation sensor 16 for detecting the rotation of the secondary pulley 3 serving as a rotary body, a signal from a pressure sensor 17 for detecting the primary pulley pressure, a signal from a pressure sensor 18 for detecting the secondary pulley pressure, and the like.

Further, the controller 12 performs various abnormality diagnoses on the basis of signals from each of the above sensors and executes a control corresponding to a content if the occurrence of an abnormality is determined.

For example, the controller 12 performs an abnormality diagnosis of the rotation sensor 14 on the basis of a signal from the rotation sensor 14, performs an abnormality diagnosis of the rotation sensor 15 on the basis of a signal from the rotation sensor 15 and performs an abnormality diagnosis of the rotation sensor 16 on the basis of a signal from the rotation sensor 16.

The abnormality diagnoses of the rotation sensors 14 to 16 are described in detail below. It should be noted that since the configuration and an abnormality diagnosis process of each rotation sensor 14 to 16 are similar, the abnormality diagnosis of the rotation sensor 14 is described as an example and the abnormality diagnoses of the rotation sensors 15 and 16 are not described below.

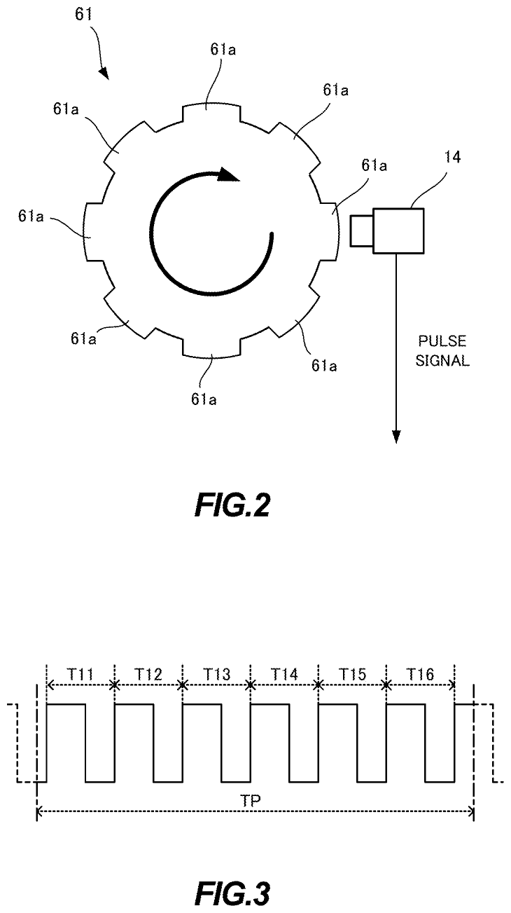

First, the rotation sensor 14 is described with reference to FIG. 2. The rotation sensor 14 is a so-called proximity sensor and detects detection parts 61a provided on the output shaft 61 serving as a rotary body for transmitting rotation input from the engine 5 to the drive wheels 50, and outputs pulse signals.

In the present embodiment, the output shaft 61 is provided with the detection parts 61a at eight positions equally spaced apart in a circumferential direction. Thus, if the output shaft 61 makes one turn, the pulse signal is output from the rotation sensor 14 eight times. It should be noted that the number of the detection parts 61a can be changed as appropriate.

The controller 12 computes a rotation speed of the output shaft 61 on the basis of the number of the pulse signals input from the rotation sensor 14 in a predetermined period TP. For example, six pulse signals are input in the predetermined period TP in FIG. 3.

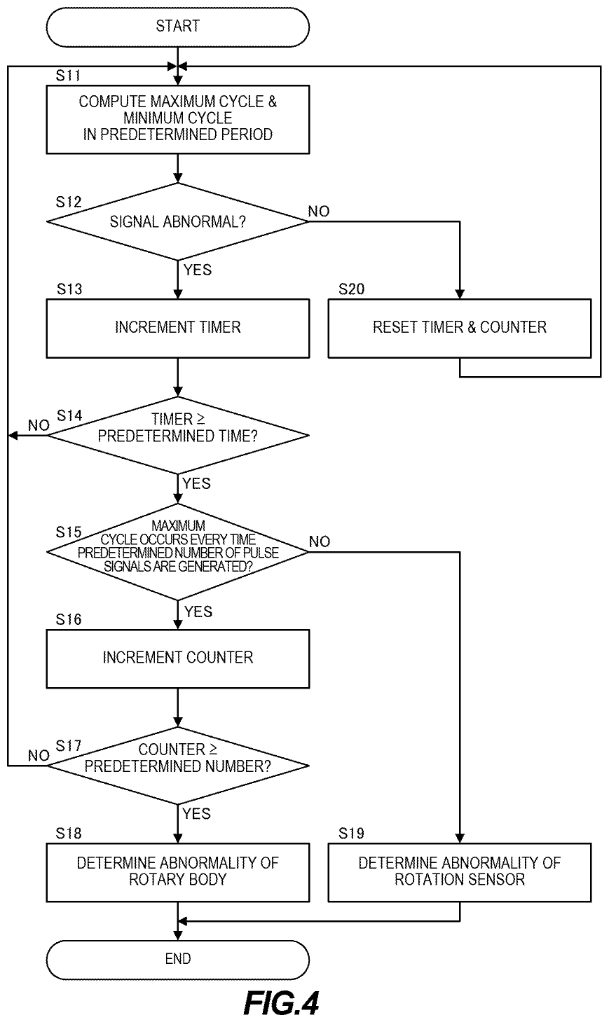

Next, an abnormality diagnosis process performed by the controller 12 is described with reference to a flow chart of FIG. 4. It should be noted that the controller 12 repeatedly performs the abnormality diagnosis process in a state where an ignition switch is on. A computation cycle of the CPU 12a is, for example, 10 ms.

In Step S11, the controller 12 computes a maximum cycle and a minimum cycle for a plurality of pulse signals input from the rotation sensor 14 in the predetermined period TP. In the present embodiment, the predetermined period TP is set equal to the computation cycle of the CPU 12a.

In Step S12, the controller 12 determines whether or not a signal of the rotation sensor 14 is abnormal on the basis of the maximum cycle and the minimum cycle computed in Step S11.

Specifically, the controller 12 determines that the signal of the rotation sensor 14 is abnormal if a difference between the maximum cycle and the minimum cycle computed in Step S11 exceeds a determination time. The determination time is, for example, several μs to several tens of μs.

For example, since cycles T11 to T16 of the respective pulse signals in the predetermined period TP are substantially equal in a case shown in FIG. 3, the difference between the maximum cycle and the minimum cycle of the cycles T11 to T16 does not exceed the determination time. Thus, in this case, the controller 12 determines that the signal of the rotation sensor 14 is normal and proceeds the process to Step S20.

In Step S20, the controller 12 resets values of a timer and a counter and proceeds the process to Step S11. The timer and the counter will be described later.

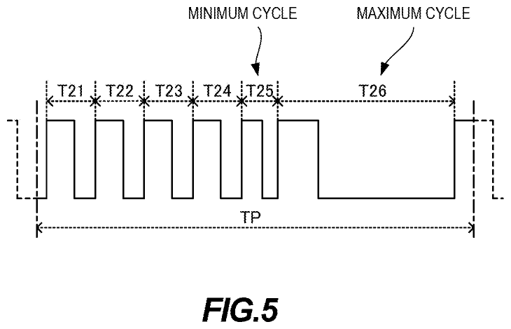

On the other hand, for example, in a case shown in FIG. 5, a difference between a cycle T26 and a cycle T25, which are a maximum cycle and a minimum cycle of cycles T21 to T26 of respective pulse signals in the predetermined period TP, is large and exceeds the determination time. Thus, in this case, the controller 12 determines that the signal of the rotation sensor 14 is abnormal and proceeds the process to Step S13.

As described above, the rotation sensor 14 is a sensor for detecting the detection parts 61a approaching by the rotation of the output shaft 61. Since the detection parts 61a are provided at eight positions of the output shaft 61 equally spaced apart in the circumferential direction, a large variation of the cycles of the pulse signals in a short period such as the predetermined period TP cannot occur in a normal state.

Accordingly, if the difference between the maximum cycle and the minimum cycle exceeds the determination time in the predetermined period TP, i.e. if the cycles of the pulse signals largely vary in a short period, the controller 12 determines that the signal of the rotation sensor 14 is abnormal.

It should be noted that if the rotation speed of the output shaft 61 is constant, the controller 12 sets the determination time of Step S12 such that a variation in the number of the pulse signals in every predetermined period TP is ±1. The rotation speed of the output shaft 61 is constant, for example, when a vehicle speed is constant.

If the rotation speed of the output shaft 61 is constant, the variation in the number of the pulse signals in every predetermined period TP is within a range of ±1 even if the pulse signals are shifted or vary in the predetermined period TP. Thus, if the variation exceeds this range, the signal of the rotation sensor 14 is determined to be abnormal, whereby the accuracy of the abnormality diagnosis can be improved.

Further, the determination of Step S12 may be made such that the signal of the rotation sensor 14 is abnormal if a value obtained by dividing either one of the maximum cycle and the minimum cycle by the other is outside a predetermined range.

In Step S13, the controller 12 increments the value of the timer.

In Step S14, the controller 12 determines whether or not the value of the timer has reached a predetermined time or more. The predetermined time is, for example, 100 ms.

If the value of the timer is determined to have reached the predetermined time or more, the controller 12 proceeds the process to Step S15. Further, if it is determined that the value of the timer has not reached the predetermined time or more, the controller 12 proceeds the process to Step S11.

In Step S15, the controller 12 determines whether or not the maximum cycle of each predetermined period TP is occurring every time a predetermined number of the pulse signals are generated. The predetermined number of the pulse signals is less than the number of the detection parts 61a by 1, and 7 pulses in the present embodiment.

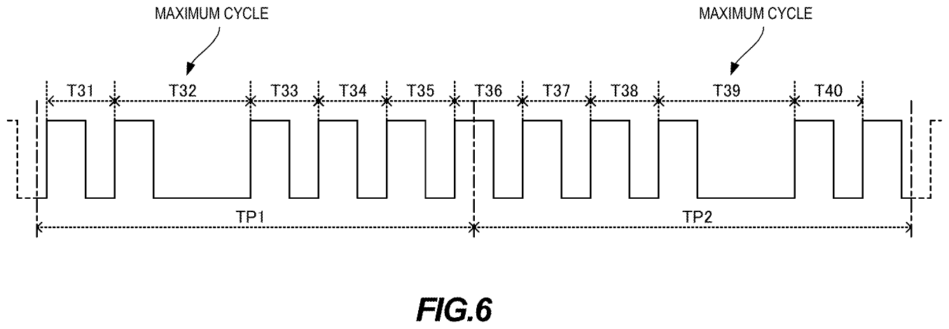

For example, in FIG. 6, the maximum cycle of the pulse signal in a predetermined period TP1 is a cycle T32 and the maximum cycle of the pulse signal in the next predetermined period TP2 is a cycle T39. That is, the maximum cycle occurs every seven pulses. Thus, in this case, the controller 12 determines that the maximum cycle occurs every time the predetermined number of the pulse signals are generated and proceeds the process to Step S16.

Further, if it is determined that the maximum cycle does not occur every time the predetermined number of the pulse signals are generated, the controller 12 proceeds the process to Step S19 and determines that the rotation sensor 14 is abnormal.

If the maximum cycle occurs every time the predetermined number of the pulse signals are generated, it is thought that the rotation sensor 14 has no abnormality and the detection part 61a is broken. Thus, in such a case, the abnormality of the rotation sensor 14 is not determined. In this way, the rotation sensor 14 can be prevented from being erroneously determined to be abnormal although the rotation sensor 14 has no abnormality.

In Step S16, the controller 12 increments the value of the counter.

In Step S17, the controller 12 determines whether or not the value of the counter has reached a predetermined value or more. The predetermined value is, for example, 10.

If the value of the counter is determined to have reached the predetermined value or more, the controller 12 proceeds the process to Step S18 and determines that the output shaft 61 is abnormal. Further, if it is determined that the value of the counter has not reached the predetermined value or more, the controller 12 proceeds the process to Step S11.

As just described, since the breakage of the detection parts 61a can be detected in the present embodiment, it is possible to exchange only a broken part and cost for repair can be reduced.

Next, effects of performing the abnormality diagnosis of the rotation sensor 14 as described above are summarized.

To perform an abnormality diagnosis of a rotation sensor, it is, for example, thought to perform an abnormality diagnosis of one rotation sensor based on pulse signals from two rotation sensors. However, in this case, at least two rotation sensors are necessary to perform the abnormality diagnosis of the rotation sensor. That is, the abnormality diagnosis of a rotation sensor cannot be performed if there is only one rotation sensor.

In contrast, the controller 12 of the present embodiment performs the abnormality diagnosis of the rotation sensor 14 on the basis of the maximum cycle and the minimum cycle of a plurality of pulse signals in the predetermined period TP.

Specifically, the controller 12 determines that the rotation sensor 14 is abnormal if the difference between the maximum cycle and the minimum cycle exceeds the determination time.

Further, if a value obtained by dividing either one of the maximum cycle and the minimum cycle by the other is outside the predetermined range, the rotation sensor 14 is determined to be abnormal.

According to this, even if there is one rotation sensor, an abnormality diagnosis of this rotation sensor can be performed.

Further, if the rotation speed of the output shaft 61 is constant, the controller 12 sets the determination time such that a variation in the number of the pulse signals in every predetermined period is ±1.

If the rotation speed of the output shaft 61 is constant, the variation in the number of the pulse signals in every predetermined period TP is within the range of ±1 even if the pulse signals are shifted or vary in the predetermined period TP. Thus, if the variation exceeds this range, the accuracy of the abnormality diagnosis can be improved by determining that the signal of the rotation sensor 14 is abnormal.

Further, the controller 12 determines that the output shaft 61 is abnormal if the pulse signal having the maximum cycle is generated every time the pulse signals less than the number of the detection parts 61a provided on the output shaft 61 by 1 are generated.

If the maximum cycle occurs every time pulse signals less than the number of the detection parts 61a by 1 are generated, it is thought that the rotation sensor 14 has no abnormality and the detection part 61a is broken. Thus, in such a case, it is determined that not the rotation sensor 14, but the output shaft 61 has an abnormality. In this way, the rotation sensor 14 can be prevented from being erroneously determined to be abnormal although the rotation sensor 14 has no abnormality. Further, since the breakage of the detection parts 61a can be detected, it is possible to exchange only the broken part and cost for repair can be reduced.

Further, the predetermined period TP is the computation cycle of the CPU 12a.

According to this, since the predetermined period TP can be set in a minimum unit, the accuracy of the abnormality diagnosis is improved.

Although the embodiment of the present invention has been described above, the above embodiment is merely an illustration of one application example of the present invention and not intended to limit the technical scope of the present invention to the specific configuration of the above embodiment.

For example, the controller 12 integrally controls the engine 5, the automatic transmission 1 and the like in the above embodiment. However, the controller 12 may be constituted by a plurality of controllers.

Further, in the above embodiment, the automatic transmission 1 is a continuously variable automatic transmission. However, the automatic transmission 1 may be a stepped automatic transmission.

Further, a motor generator may be provided instead of or together with the engine 5 as a drive source of the vehicle 100.

Further, although the abnormality diagnosis of the rotation sensor 14 has been described as an example in the above embodiment, abnormality diagnoses can be similarly performed for the rotation sensors 15 and 16 as described above. Further, the present invention may be applied to rotation sensors other than the rotation sensors 14 to 16.

Further, although the abnormality diagnosis is performed on the basis of the cycles of the pulse signals in the above embodiment, the cycles of the pulse signals can be replaced by widths of the pulse signals or widths between the pulse signals. That is, the abnormality diagnosis performed on the basis of the widths of the pulse signals or the widths between the pulse signals is encompassed by the abnormality diagnosis performed on the basis of the cycles of the pulse signals.

With respect to the above description, the contents of application No. 2017-126478, with a filing date of Jun. 28, 2017 in Japan, are incorporated herein by reference.

1. An automatic transmission control device for an automatic transmission with a rotary body for transmitting rotation input from a drive source to drive wheels and a rotation sensor for detecting detection parts provided on the rotary body and outputting pulse signals, wherein:
the automatic transmission control device is configured to perform an abnormality diagnosis of the rotation sensor on the basis of a maximum cycle and a minimum cycle of a plurality of the pulse signals in a predetermined period.

2. The automatic transmission control device according to claim 1, wherein:
The automatic transmission control device is configured to determine that the rotation sensor is abnormal if a difference between the maximum cycle and the minimum cycle exceeds a determination time.

3. The automatic transmission control device according to claim 1, wherein:
the automatic transmission control device is configured to determine that the rotation sensor is abnormal if a value obtained by dividing either one of the maximum cycle and the minimum cycle by the other is outside a predetermined range.

4. The automatic transmission control device according to claim 2, wherein:
the automatic transmission control device is configured to set the determination time such that a variation in the number of the pulse signals in every predetermined period is ±1 if a rotation speed of the rotary body is constant.

5. The automatic transmission control device according to claim 1, wherein:
the automatic transmission control device is configured to determine that the rotary body is abnormal if the pulse signal having the maximum cycle is generated every time the pulse signals less than the number of the detection parts provided on the rotary body by 1 are generated even when the pulse signals output by the rotation sensor are determined to be abnormal on the basis of the maximum cycle and the minimum cycle.

6. The automatic transmission control device according to claim 1, wherein:
the predetermined period is a computation cycle of a CPU.

7. An automatic transmission control method for an automatic transmission with a rotary body for transmitting rotation input from a drive source to drive wheels and a rotation sensor for detecting detection parts provided on the rotary body and outputting pulse signals, comprising:
performing an abnormality diagnosis of the rotation sensor on the basis of a maximum cycle and a minimum cycle of a plurality of the pulse signals in a predetermined period.

8. An automatic transmission control device for an automatic transmission with a rotary body for transmitting rotation input from a drive source to drive wheels and a rotation sensor for detecting detection parts provided on the rotary body and outputting pulse signals, comprising:
diagnosis means for performing an abnormality diagnosis of the rotation sensor on the basis of a maximum cycle and a minimum cycle of a plurality of the pulse signals in a predetermined period.
